(19) United States
(12) Patent Application Publication
(10) Pub. No.: US 2013/0179455 A1
(43) Pub. Date: Jul. 11, 2013

(54) COLLABORATION DATA ORGANIZER

(71) Applicants: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(72) Inventors: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(73) Assignee: International Business Machines Corporation, Armonk, NY (US)

(21) Appl. No.: 13/345,870

(22) Filed: Jan. 9, 2012

(51) Int. Cl. G06F 17/30

(52) U.S. Cl. 707/749; 707/752; 707/E17.014

(57) ABSTRACT

A system and method for organizing information relevant to a collaboration. An example method includes automatically calculating by a computer processor a relevance value of user-encountered information respective to the collaboration. The method also includes distributing to at least one attendee of the collaboration the user-encountered information if the relevance value is beyond a relevance threshold.

### BACKGROUND

This invention relates to collaboration, and more particularly to a system and method for organizing data relevant to a collaboration.

Users constantly encounter information through browsing web pages, browsing e-book pages, listening to audio broadcasts, viewing video broadcasts, and a variety of other activities. Some of this information is relevant to collaborations of which the user is a part and the user may wish to share this information with other collaborators. Currently, in order for the user to share this information with others, she will typically manually record each source of relevant information and then manually distribute the information to those with whom she wishes to share it. This process can be inefficient and may lead to communication breakdowns between collaborators, often resulting in delays and ineffective outputs.

### SUMMARY

Accordingly, one aspect of the present invention is a system that automatically determines the relevancy of user encountered information to pending collaborations and distributes relevant information to each collaborative user. One example of the present invention is a method for organizing information relevant to a collaboration. The method includes automatically calculating by a computer processor a relevance value of user-encountered information respective to the collaboration. The method also includes distributing to at least one attendee of the collaboration the user-encountered information if the relevance value is beyond a relevance threshold.

Another example of the present invention is a system for organizing information relevant to a collaboration. The system includes a computer processor configured to calculate a relevance value of user-encountered information respective to the collaboration. The computer processor is further configured to distribute to at least one attendee the user-encountered information if the relevance value is beyond a relevance threshold.

Yet another example of the present invention is a computer readable medium encoding instructions for performing a method for organizing information relevant to a collaboration. The method includes determining the relevancy of user-encountered information respective to the collaboration and distributing relevant user-encountered information to collaboration attendees. The method also includes determining the relevancy of the collaboration respective to potential attendees and distributing relevant collaboration details to these potential attendees.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a method for organizing information relevant to a collaboration in accordance with one embodiment of the invention.

FIG. 2 shows another method for organizing information relevant to a collaboration in accordance with one embodiment of the present invention.

FIG. 3 shows another method for organizing information relevant to a collaboration in accordance with one embodiment of the present invention.

FIG. 4 shows another method for organizing information relevant to a collaboration in accordance with one embodiment of the present invention.

FIG. 5 shows another method for organizing information relevant to a collaboration in accordance with one embodiment of the present invention.

FIG. 6 shows a system for organizing information relevant to a collaboration according to one embodiment of the present invention.

FIG. 7 shows a computer-readable medium 702 encoding instructions for performing a method for organizing information relevant to a collaboration according to one embodiment of the present invention.

### DETAILED DESCRIPTION

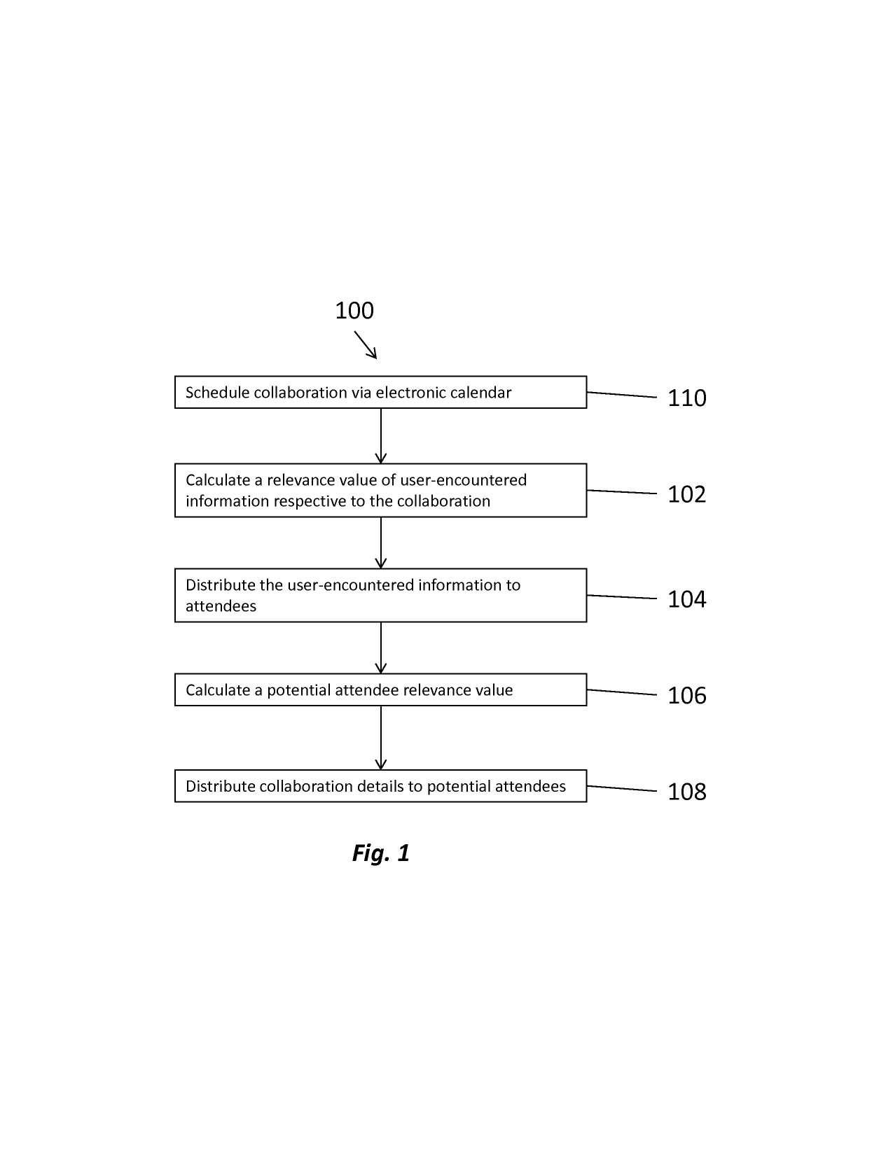

The present invention is described with reference to embodiments of the invention. Throughout the description of the invention reference is made to FIGS. 1-7. When referring to the figures, like structures and elements shown throughout are indicated with like reference numerals.

FIG. 1 shows a method for organizing information relevant to a collaboration in accordance with one embodiment of the invention. As used herein, the term collaboration may also be referred to as meeting. The method includes a scheduling step 110. During scheduling step 110, a collaboration is scheduled via electronic calendar. After the scheduling step 110 is completed, the method continues to relevance value calculation step 102.

At relevance value calculation step 102, a relevance value of user-encountered information respective to the collaboration is automatically calculated by a computer processor. After relevance value calculation step 102 is completed, the method continues to distribution step 104.

At distribution step 104, the user-encountered information is distributed to at least one attendee of the collaboration if the relevance value calculated in relevance value calculation step 102 is beyond a relevance threshold. After distribution step 104 is completed, the method continues to potential attendee relevance calculation step 106.

At potential attendee relevance calculation step 106, a potential attendee relevance value of the collaboration respective to at least one attendee is automatically calculated. After potential attendee calculation step 106 is completed, the method continues to potential attendee distribution step 108.

At potential attendee distribution step 108, the details of the collaboration are distributed to at least one potential attendee if the relevance value calculated in step 106 is beyond a potential attendee relevance threshold.

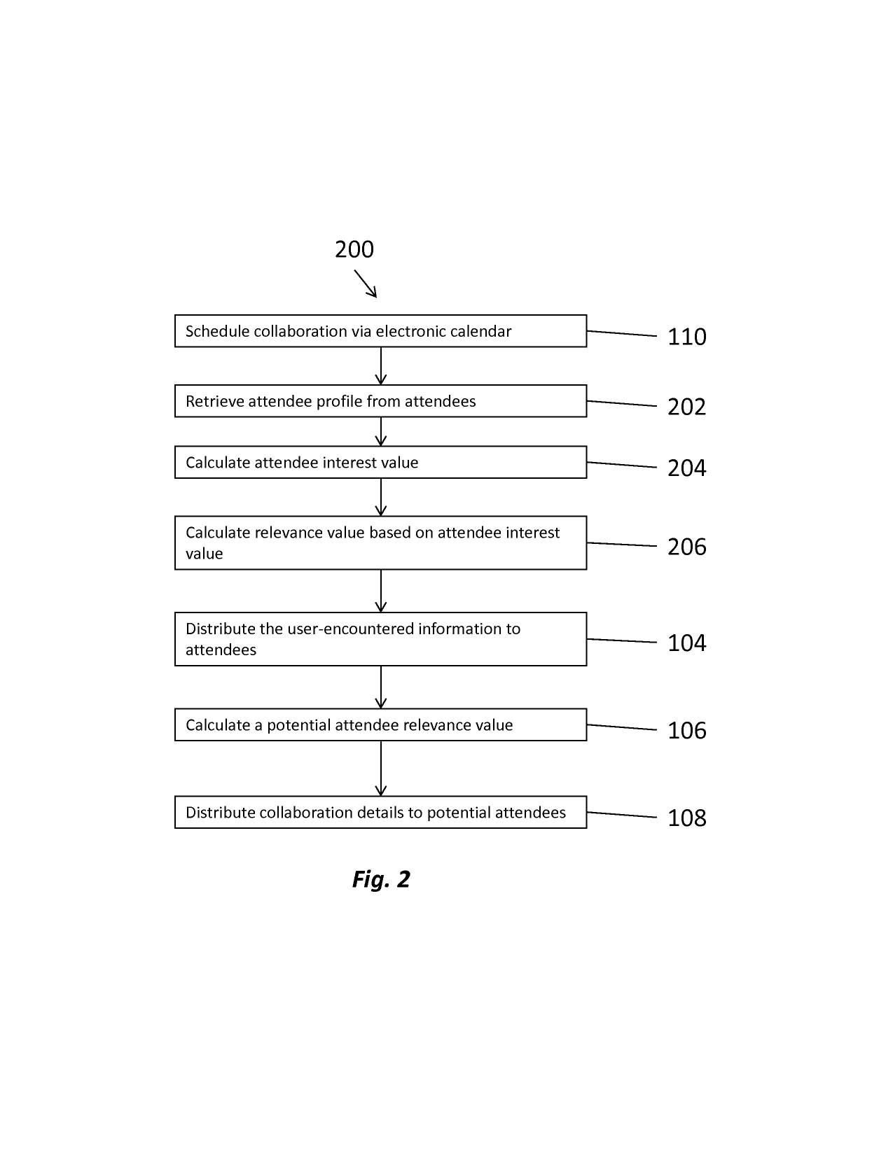

FIG. 2 shows another method for organizing information relevant to a collaboration in accordance with one embodiment of the present invention. The method includes a scheduling step 110. During step 110, a collaboration is scheduled via electronic calendar. After the scheduling step 110 is completed, the method continues to attendee profile retrieval step 202.

At attendee profile retrieval step 202, attendee profiles are retrieved from at least one meeting attendee. After attendee profile retrieval step 202 is completed, the method continues to attendee interest value calculation step 204.

At attendee interest value calculation step 204, an attendee interest value is automatically calculated based on the attendee profiles retrieved in attendee profile retrieval step 202. After attendee interest value calculation step 204 is completed, the method continues to the calculation of a relevance value based on attendee interest value step 206.

At the calculation of a relevance value based on attendee interest value step 206, a relevance value is automatically calculated based at least partly on the attendee interest value calculated in attendee interest value calculation step 204. After the calculation of a relevance value based on attendee interest value step 206, the method continues to distribution step 104.

At distribution step 104, the user-encountered information is distributed to at least one attendee of the collaboration if the relevance value calculated in step 102 is beyond a relevance threshold. After distribution step 104 is completed, the method continues to potential attendee relevance calculation step 106.

At potential attendee relevance calculation step 106, a potential attendee relevance value of the collaboration respective to at least one attendee is automatically calculated. After potential attendee calculation step 106 is completed, the method continues to potential attendee distribution step 108.

At potential attendee distribution step 108, the details of the collaboration are distributed to at least one potential attendee if the relevance value calculated in step 106 is beyond a potential attendee relevance threshold.

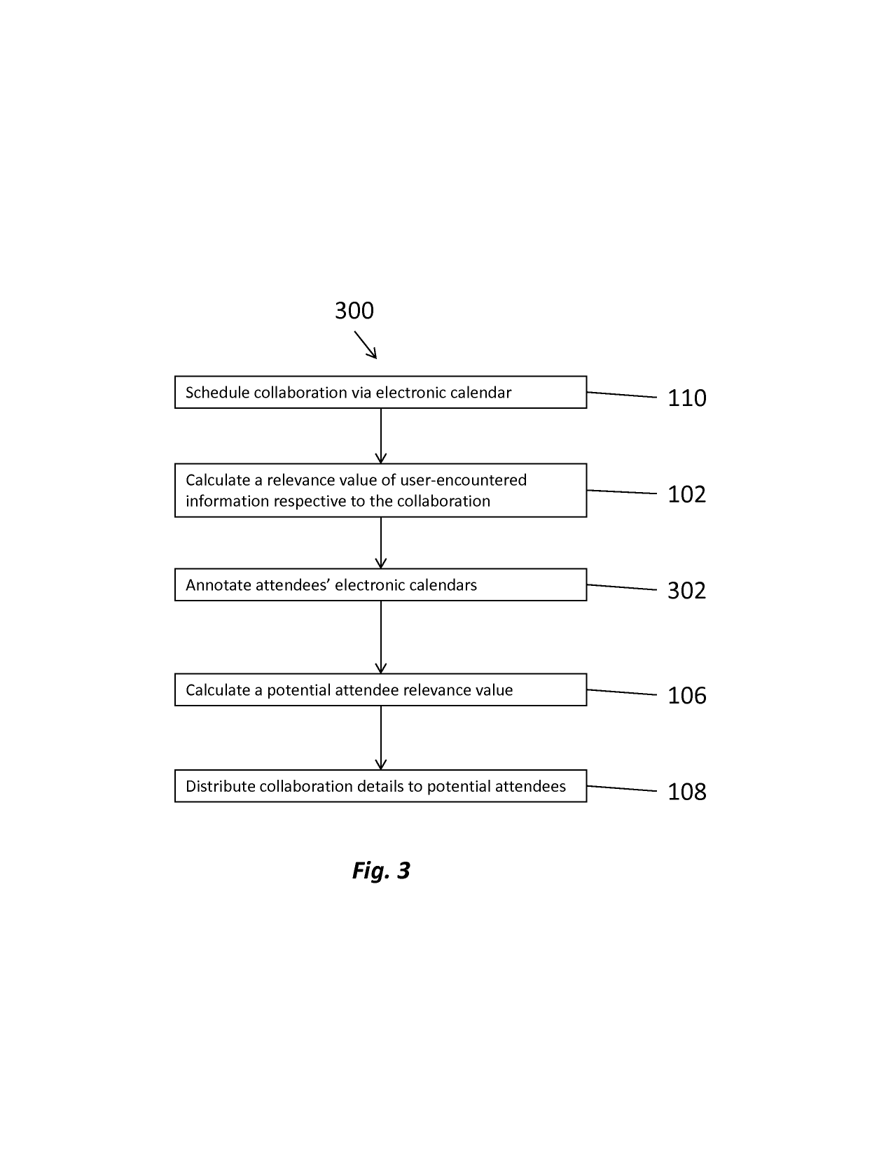

FIG. 3 shows another method for organizing information relevant to a collaboration in accordance with one embodiment of the present invention. The method includes a scheduling step 110. During step 110, a collaboration is scheduled via electronic calendar. After the scheduling step 110 is completed, the method continues to relevance value calculation step 102.

At relevance value calculation step 102, a relevance value of user-encountered information respective to the collaboration is automatically calculated by a computer processor. After relevance value calculation step 102 is completed, the method continues to electronic calendar annotation step 302.

At electronic calendar annotation step 302, the user-encountered information is annotated on at least one attendee's electronic calendar. After electronic calendar annotation step 302, the method continues to potential attendee relevance calculation step 106.

At potential attendee relevance calculation step 106, a potential attendee relevance value of the collaboration respective to at least one attendee is automatically calculated. After potential attendee calculation step 106 is completed, the method continues to potential attendee distribution step 108.

At potential attendee distribution step 108, the details of the collaboration are distributed to at least one potential attendee if the relevance value calculated in step 106 is beyond a potential attendee relevance threshold.

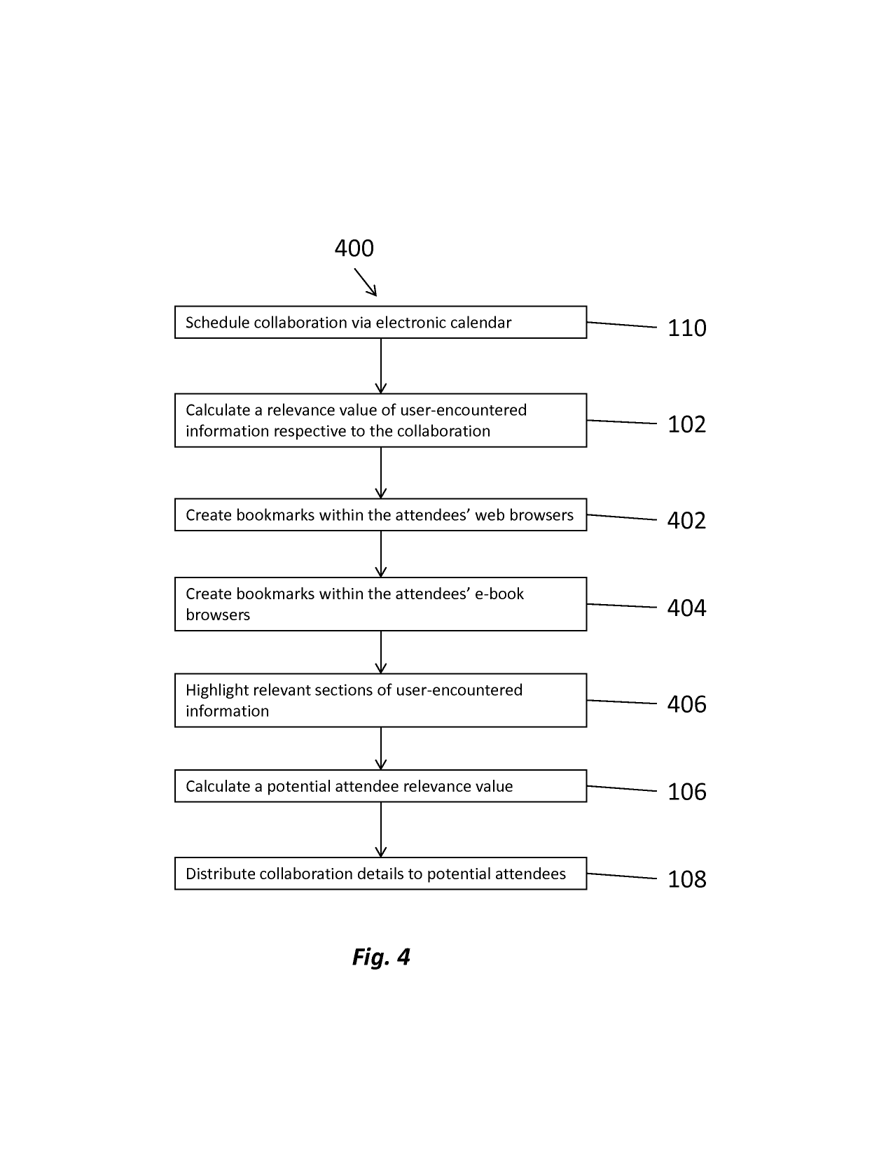

FIG. 4 shows another method for organizing information relevant to a collaboration in accordance with one embodiment of the present invention. The method includes a scheduling step 110. During step 110, a collaboration is scheduled via electronic calendar. After the scheduling step 110 is completed, the method continues to relevance value calculation step 102.

At relevance value calculation step 102, a relevance value of user-encountered information respective to the collaboration is automatically calculated by a computer processor. After relevance value calculation step 102 is completed, the method continues to web browser bookmark creation step 402.

At web browser bookmark creation step 402, a bookmark is created within the web browser of at least one attendee. After web browser bookmark creation step 402, the method continues to e-book browser bookmark creation step 404.

At e-book browser bookmark creation step 404, a bookmark is created within the e-book browser of at least one attendee. After e-book browser bookmark creation step 404, the method continues to highlighting step 406.

At highlighting step 406, at least one relevant section of the user-encountered information that has been distributed to at least one attendee is highlighted. After highlighting step 406, the method continues to potential attendee relevance calculation step 106.

At potential attendee relevance value calculation step 106, a potential attendee relevance value of the collaboration respective to at least one attendee is automatically calculated. After potential attendee relevance value calculation step 106 is completed, the method continues to potential attendee distribution step 108.

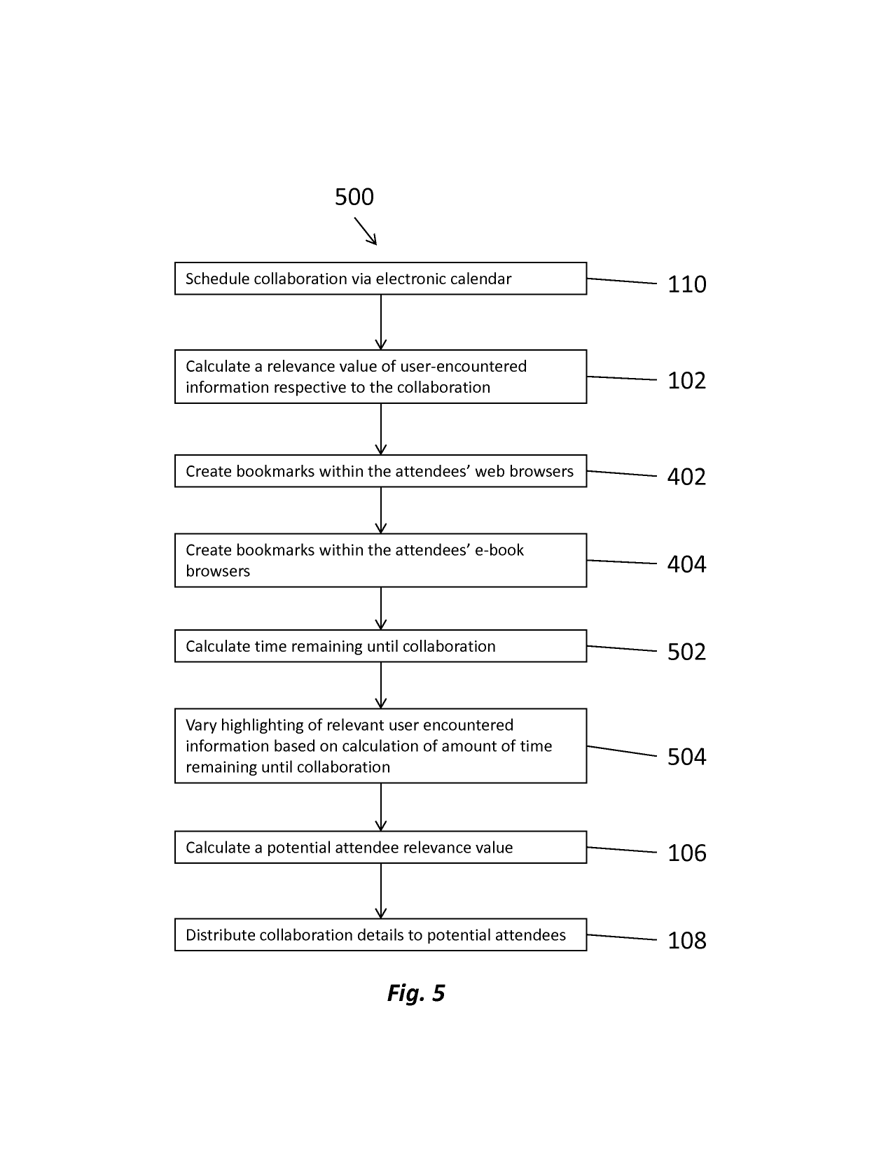

FIG. 5 shows another method for organizing information relevant to a collaboration in accordance with one embodiment of the present invention. The method includes a scheduling step 110. During step 110, a collaboration is scheduled via electronic calendar. After the scheduling step 110 is completed, the method continues to relevance value calculation step 102.

At relevance value calculation step 102, a relevance value of user-encountered information respective to the collaboration is automatically calculated by a computer processor. After relevance value calculation step 102 is completed, the method continues to web browser bookmark creation step 402.

At web browser bookmark creation step 402, a bookmark is created within the web browser of at least one attendee. After web browser bookmark creation step 402, the method continues to e-book browser bookmark creation step 404.

At e-book browser bookmark creation step 404, a bookmark is created within the e-book browser of at least one attendee. After e-book browser bookmark creation step 404, the method continues to time remaining until collaboration calculation step 502.

At time remaining until collaboration calculation step 502, an amount of time remaining prior to the collaboration is automatically calculated. After time remaining until collaboration calculation step 502, the method continues to highlighting variation step 504.

At highlighting variation step 504, the highlighting of at least one relevant section of user-encountered information that has been distributed to at least one attendee is varied based on the amount of time remaining prior to the collaboration calculated in time remaining until collaboration calculation step 502. After highlighting variation step 504, the method continues to potential attendee relevance calculation step 106.

At potential attendee relevance calculation step 106, a potential attendee relevance value of the collaboration respective to at least one attendee is automatically calculated. After potential attendee calculation step 106 is completed, the method continues to potential attendee distribution step 108.

At potential attendee distribution step 108, the details of the collaboration are distributed to at least one potential attendee if the relevance value calculated in step 106 is beyond a potential attendee relevance threshold.

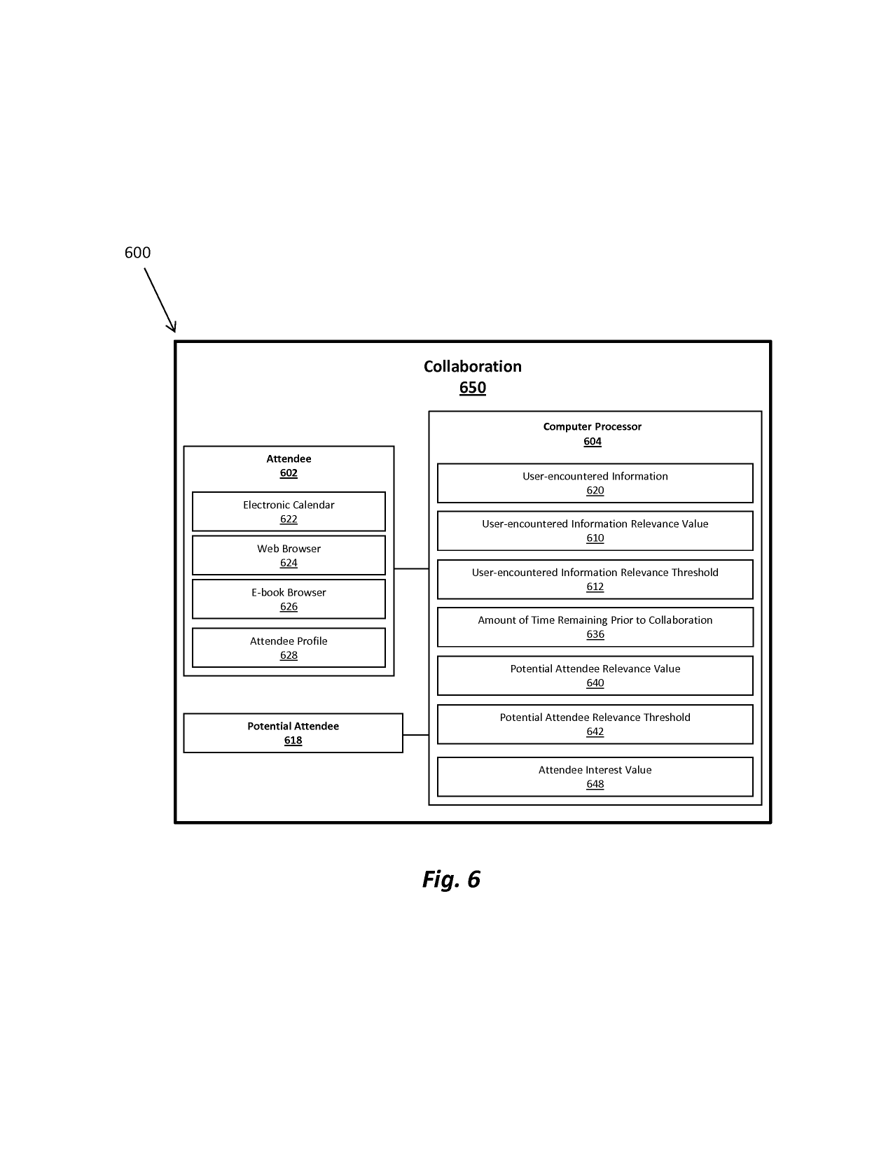

FIG. 6 shows a system for organizing information relevant to a collaboration 650 according to one embodiment of the present invention. The system includes a computer processor 604, at least one attendee 602 of the collaboration 650, and at least one potential attendee 618 of the collaboration 650.

In one embodiment, the computer processor 604 is configured to calculate a relevance value of user-encountered information respective to the collaboration 610. In addition, the computer processor 604 is configured to distribute to the attendee 602 the user-encountered information 620 if the relevance value 610 of user-encountered information respective to the collaboration is beyond a relevance threshold 612.

In another embodiment, the computer processor 604 is further configured to schedule the collaboration 650 on at least one user's electronic calendar 622. The computer processor 604 may further annotate the user-encountered information 620 on the attendee's electronic calendar 622.

In another embodiment, the computer processor 604 is further configured to create a web browser bookmark within the attendee's web browser 624. The computer processor 604 may also create an e-book browser bookmark within the attendee's e-book browser 626. The computer processor 604 may further be configured to highlight at least one relevant section of user-encountered information 620.

In another embodiment, the computer processor 604 is further configured to calculate an amount of time remaining prior to the collaboration 636. In addition, the computer processor 604 is configured to vary the highlighting of a relevant section of user-encountered information 620 based on the amount of time remaining prior to the collaboration 636.

In another embodiment, the computer processor 604 is further configured to calculate a potential attendee relevance value 640 of the collaboration respective to at least one potential attendee 618. The computer processor 604 may distribute details of the collaboration 650 to the potential attendee 618 if the relevance value of the collaboration respective to the potential attendee 640 is beyond a potential attendee relevance threshold 642.

In another embodiment, the computer processor 604 is further configured to retrieve an attendee profile 628 from the attendee 602. In addition, the computer processor 604 is configured to calculate an attendee interest value 648 based on the attendee profile 628. Furthermore, the computer processor 604 is configured to base the calculation of the relevance value of user-encountered information respective to the collaboration 610, at least in part, on the attendee interest value 648.

Accordingly, in one embodiment of the present invention, a user encounters information by browsing web pages, e-book pages, videos, radio broadcasts, and related electronic content, which may be conceptually associated with scheduled future meetings on an electronic calendar. For example, a user may be viewing a web page on the topic of cloud computing, and the user has been invited to a future meeting on the topic of cloud computing.

According to this embodiment, a computer processor analyzes the content of information encountered by a user, including, but not limited to, web pages, e-book pages, videos, radio broadcasts, and related electronic content.

Additionally, a computer processor analyzes content associated with electronic calendar entries, including, but not limited to, the subject matter of the meeting content and the length of time remaining prior to the occurrence of the meeting.

A computer processor analyzes content associated with the meeting attendees invited to attend scheduled meetings. This content could include number of attendees, job titles of attendees, organizational ranks of attendees, experience levels of attendees, or other information associated with meeting attendees.

Based on the analyses of user-encountered information, content associated with calendar entries, and/or content associated with meeting attendees, a calendar related action is taken. This calendar related action may include a dialogue box that facilitates the transmission of all or a part of the user-encountered information to at least one meeting attendee. For example, a URL of a web page on cloud computing may be emailed to a meeting attendee predicted or known to be at a future scheduled meeting discussing the topic of cloud computing.

The calendar related action may also include annotating a calendar entry with relevant user-encountered information or with a pointer to direct attendees to relevant user-encountered information. This pointer may be a hyperlink or similar association.

Additionally, the calendar related action may include creating a web browser bookmark to a relevant user-encountered web page or creating an e-book browser bookmark to relevant user-encountered e-book content.

The calendar related action may also include highlighting the relevant sections of user-encountered information. Highlighting could include illuminating relevant sections within user-encountered web pages, e-book pages, and other documents. Additionally, highlighting could include audible tones or visual alerts at relevant segments of radio broadcasts, podcasts, videos, and other forms of audio and visual communications.

Additionally, the calendar related action may also include creating an entirely new meeting relevant to the user-encountered information.

The content analyses may use known techniques for topic extraction (e.g., latent semantic indexing, keyword analysis, document tags, etc.) in order to determine the topic of the user-encountered information. For example, if a web page or e-book being browsed is titled “Cloud Computing in the Next Ten Years,” the computer processor can determine that “cloud computing” is one of the topics of the browsed document. If the phrase “cloud computing security” is uttered seven times in a YouTube video, the computer processor can determine that “cloud computing security” is one of the topics of the video.

The nature and number of meeting attendees may be used to make annotation decisions such as whether or not an annotation is made and the type of annotation to be made. For example, if a scheduled meeting has the employee's manager and vice president in attendance, the annotation may be more likely to occur. Also, if the title of the vice president is “Vice President of Cloud Computing,” the calendar annotation may be more likely to occur on a meeting covering the topic of “cloud computing.” Known social-network analysis tools and company databases may be used to determine relationships between users and meeting attendees and thus be used to affect the nature of the calendar related action.

As an example, a user is browsing a web page that discusses the future of cloud computing. The computer processor may use known techniques (e.g., latent semantic indexing, keywords, etc.) to determine the topic of the web page or other user-encountered information. The user-encountered information may also be in the form of multimedia, including audio and video, in which case speech recognition and other methods can be used to determine the topic of the information. This topic may then be searched for in a user's electronic calendar. For example, a user's calendar may contain a future meeting on the topic of cloud computing, where this meeting topic is determined based on analysis of the calendar meeting title, associated calendar text, or even an analysis of the job-titles of meeting attendees. Once this correlation between the topic of user-encountered information is made with a meeting on a user's calendar, the user may be prompted as to whether she would like to convey this information in advance of the meeting to attendees, have the content appear on the calendar entry as an annotation, create a bookmark associated with the content, or perform another calendar related action. Alternatively, no prompt may be given, and the content of the user-encountered information may be automatically associated with one or more calendar entries.

According to one embodiment contemplated by the present invention, the computer processor analyzes content associated with the calendar entries of colleagues of the user so as to provide relevant user-encountered information to these colleagues, e.g., fellow company employees, even if the current user is not invited to the meeting. For example, if one user is browsing an article titled “Cloud Computing and Virtual Private Networks,” and her colleague has a meeting scheduled on her calendar with this same title, then the colleague's calendar entry may be annotated so that the colleague is aware of the article. This may take place rapidly; for example, within seconds of the user browsing “Cloud Computing and Virtual Private Networks,” a calendar annotation is made.

In another embodiment contemplated by the present invention, the document being browsed is highlighted (e.g., becomes illuminated, changes color, makes a sound, etc.) to inform the user of a relationship between the user-encountered information and a meeting. If the user-encountered information is a multimedia document (e.g., broadcast), it may be marked in a multimedia fashion (e.g., by adding a sound). For example, if the user is browsing a web page on Cloud Computing, the web page may be marked with a watermark because the system has determined that a meeting on this subject occurs within a week. The nature of the marking may be time dependent. For example, one mark may be used if the meeting is scheduled to occur within one day, and another may be used if the meeting is scheduled to occur within one week.

Note that ideas contemplated by embodiments of this invention may be extended to other electronic tools. For example, if a relevant correlation or relationship is found between user-encountered information and a to-do list, a follow-up list, a reminder program, or related software tool, then these other kinds of tools may have automated marking functions. For instance, if a user is browsing a web page on Cloud Computing, an existing to-do list entry on this subject may be annotated with the URL for the web page.

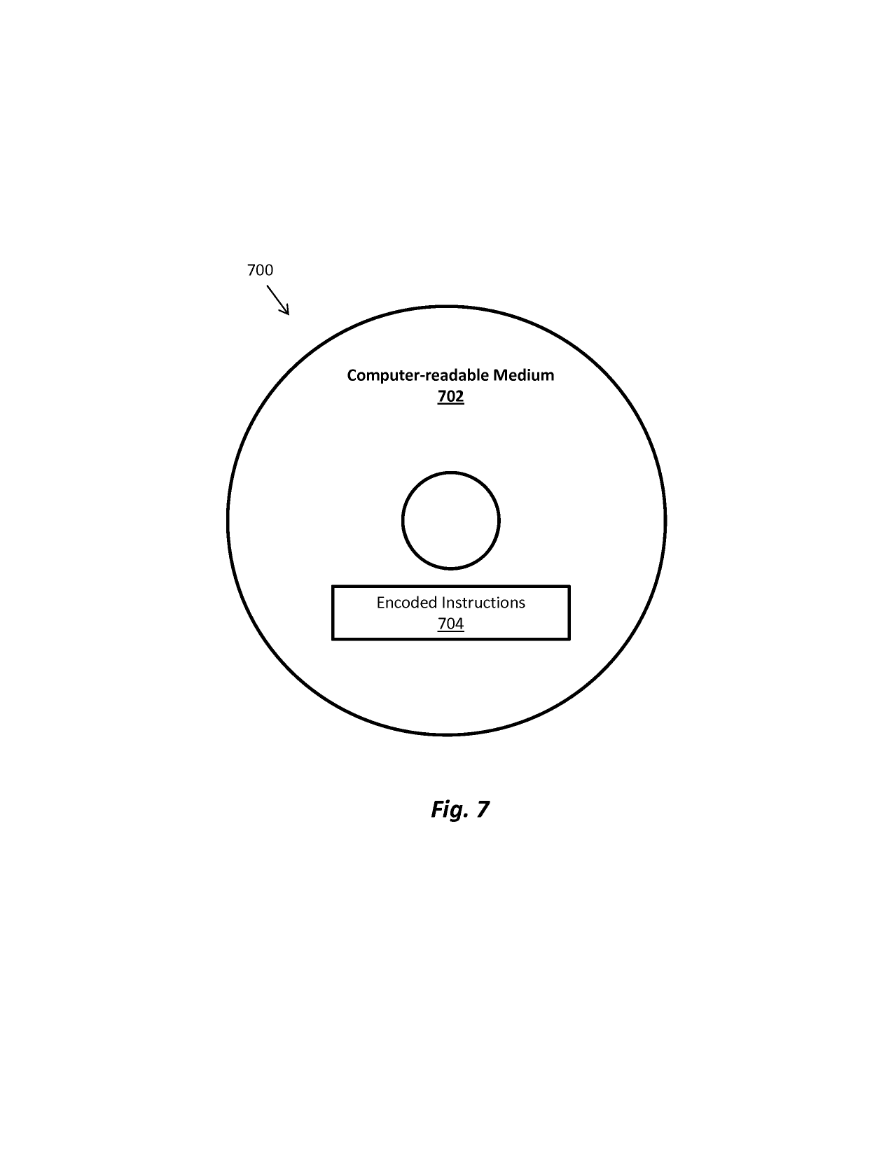

FIG. 7 shows a computer-readable medium 702 encoding instructions for performing a method for organizing information relevant to a collaboration 704 according to one embodiment of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for organizing information relevant to a collaboration, the method comprising:
automatically calculating by a computer processor a relevance value of user-encountered information respective to the collaboration; and
distributing to at least one attendee of the collaboration the user-encountered information if the relevance value is beyond a relevance threshold.

2. The method of claim 1, further comprising scheduling the collaboration via electronic calendar if the relevance value is beyond the relevance threshold.

3. The method of claim 2, wherein distributing the user-encountered information includes annotating the user-encountered information on at least one attendee's electronic calendar.

4. The method of claim 3, wherein annotating the user-encountered information on the attendee's electronic calendar includes at least one of creating a bookmark within a web browser of the attendee and creating a bookmark within an e-book browser of the attendee.

5. The method of claim 3, wherein annotating the user-encountered information on the attendee's electronic calendar includes highlighting at least one relevant section of the user-encountered information.

6. The method of claim 5, wherein highlighting at least one relevant section of the user encountered information further comprises:
automatically calculating an amount of time remaining prior to the collaboration; and
automatically varying the highlighting based on the calculation of the amount of time remaining prior to the collaboration.

7. The method of claim 1, further comprising:
automatically calculating by the computer processor a potential attendee relevance value of the collaboration respective to at least one potential attendee; and
distributing to the potential attendee details of the collaboration if the potential attendee relevance value is beyond a potential attendee relevance threshold.

8. The method of claim 1, wherein automatically calculating by the computer processor the relevance value of user-encountered information respective to the collaboration includes:
retrieving an attendee profile from the at least one attendee; and
calculating an attendee interest value based on the attendee profile; and
wherein the relevance value is based, at least in part, on the attendee interest value.

9. A system for organizing information relevant to a collaboration, the system comprising:
a computer processor configured to:
calculate a relevance value of user-encountered information respective to the collaboration; and
distribute to at least one attendee the user-encountered information if the relevance value is beyond a relevance threshold.

10. The system of claim 9, wherein the computer processor is further configured to schedule the collaboration via electronic calendar if the relevance value is beyond the relevance threshold.

11. The system of claim 10, wherein the computer processor annotates the user-encountered information on at least one attendee's electronic calendar.

12. The system of claim 11, wherein the computer processor creates at least one of a web browser bookmark within a web browser of at least one attendee and an e-book browser bookmark within an e-book browser of the attendee.

13. The system of claim 12, wherein the computer processor highlights at least one relevant section of the user-encountered information.

14. The system of claim 13, wherein the computer processor further:
calculates an amount of time remaining prior to the collaboration; and
varies the highlighting based on the calculation of the amount of time remaining prior to the collaboration.

15. The system of claim 9, further comprising:
wherein the computer processor calculates a potential attendee relevance value of the collaboration respective to at least one potential attendee; and
wherein the computer processor distributes to at least one potential attendee details of the collaboration if the potential attendee relevance value is beyond a potential attendee relevance threshold.

16. The system of claim 9, wherein the computer processor further:
retrieves an attendee profile from at least one attendee; and
calculates an attendee interest value based on the attendee profile; and
wherein the relevance value is based, at least in part, on the attendee interest value.

17. A computer program product for organizing information relevant to a collaboration, the computer program product comprising:
a computer readable storage medium having computer readable program code embodied therewith, the computer readable program code configured to:
automatically calculate by a computer processor a relevance value of user-encountered information respective to the collaboration; and
distribute to at least one attendee of the collaboration the user-encountered information if the relevance value is beyond a relevance threshold.

18. The computer program product of claim 17, wherein the computer readable program code is further configured to schedule the collaboration via electronic calendar if the relevance value is beyond the relevance threshold.

19. The computer program product of claim 18, wherein the computer readable program code to distribute the user-encountered information includes computer readable program code configured to annotate the user-encountered information on at least one attendee's electronic calendar.

20. The computer program product of claim 19, wherein the computer readable program code to annotate the user-encountered information on the attendee's electronic calendar includes computer readable program code configured to at least one of create a bookmark within a web browser of the attendee and create a bookmark within an e-book browser of the attendee.

21. The computer program product of claim 19, wherein the computer readable program code to annotate the user-encountered information on the attendee's electronic calendar includes the computer readable program code to highlight at least one relevant section of the user-encountered information.

22. The computer program product of claim 21, wherein the computer readable program code to highlight at least one relevant section of the user encountered information further comprises computer readable program code to:
automatically calculate an amount of time remaining prior to the collaboration; and
automatically vary the highlighting based on the calculation of the amount of time remaining prior to the collaboration.

23. The computer program product of claim 19, further comprising computer readable program code to:
automatically calculate by the computer processor a potential attendee relevance value of the collaboration respective to at least one potential attendee; and
distribute to the at least one potential attendee details of the collaboration if the potential attendee relevance value is beyond a potential attendee relevance threshold.

24. The computer program product of claim 19, wherein the computer readable program code to automatically calculate by the computer processor the relevance value of user-encountered information respective to the collaboration includes computer readable program code to:
retrieve an attendee profile from the at least one attendee; and
calculate an attendee interest value based on the attendee profile; and
wherein the relevance value is based, at least in part, on the attendee interest value.
